(19) United States
(12) Patent Application Publication
(10) Pub. No.: US 2015/0273367 A1
(43) Pub. Date: Oct. 1, 2015

(54) FILTRATION MODULE AND FILTRATION APPARATUS

(71) Applicant: SUMITOMO ELECTRIC INDUSTRIES, LTD., Osaka-shi, Osaka (JP)

(72) Inventors: Hiromu Tanaka, Sennan-gun (JP); Toru Morita, Sennan-gun (JP)

(21) Appl. No.: 14/439,265

(22) PCT Filed: Apr. 9, 2014
(86) PCT No.: PCT/JP2014/060292

§ 371 Date: Apr. 29, 2015

(30) Foreign Application Priority Data
May 30, 2013 (JP) 2013-114295
Dec. 26, 2013 (JP) 2013-270471

(51) Int. Cl. B01D 29/66; B01D 29/05

(52) U.S. Cl. CPC B01D 29/661; B01D 29/05

(57) ABSTRACT

It is an object of the present invention to provide a filtration module and a filtration apparatus, each of which has excellent capability of cleaning the surfaces of hollow-fiber membranes and can maintain high filtration capability. The present invention provides a filtration module including a plurality of hollow-fiber membranes held in a state of being arranged in parallel in one direction, and holding members configured to fix both ends of the hollow-fiber membranes, in which the hollow-fiber membranes each include a support layer containing, as a main component, polytetrafluoroethylene and a filtration layer disposed on a surface of the support layer and containing, as a main component, polytetrafluoroethylene; and in which the ratio of the average length to the average outside diameter of the hollow-fiber membranes is 500 to 3,000. The hollow-fiber membranes may be arranged in parallel in the vertical direction.

### TECHNICAL FIELD

The present invention relates to a filtration module and a filtration apparatus.

### BACKGROUND ART

As solid-liquid separation treatment apparatuses used in sewage treatment and in processes for producing pharmaceuticals and the like, filtration apparatuses including filtration modules, in which a plurality of hollow-fiber membranes are bundled, are used. Examples of such filtration modules include external pressure-type filtration modules in which the pressure is increased on the outer peripheral surface side of hollow-fiber membranes, and a liquid to be treated is permeated toward the inner peripheral surface side of the hollow-fiber membranes; immersion-type filtration modules in which a liquid to be treated is permeated toward the inner peripheral surface side by means of osmotic pressure or negative pressure on the inner peripheral surface side; and internal pressure-type filtration modules in which the pressure is increased on the inner peripheral surface side of hollow-fiber membranes, and a liquid to be treated is permeated toward the outer peripheral surface side of the hollow-fiber membranes.

Among the filtration modules described above, in the external pressure-type and immersion-type filtration modules, the surfaces of each of the hollow-fiber membranes become fouled with use, for example, by adhesion of substances contained in a liquid to be treated. Therefore, if left as they are, filtration capabilities decrease. Accordingly, in the past, a cleaning method (air scrubbing) has been used in which bubbles are supplied from below a filtration module so as to scrub the surfaces of each of the hollow-fiber membranes, and furthermore, by vibrating the hollow-fiber membranes, fouling material is removed (refer to Japanese Unexamined Patent Application Publication No. 2010-42329).

### CITATION LIST

### Patent Literature

PTL 1: Japanese Unexamined Patent Application Publication No. 2010-42329

### SUMMARY OF INVENTION

### Technical Problem

In general, bubbles for cleaning the surfaces of hollow-fiber membranes are continuously supplied in order to keep the surfaces of hollow-fiber membranes clean. Consequently, if the efficiency of cleaning the surfaces of hollow-fiber membranes by using bubbles is decreased, there is a concern that the amount of energy required for supplying bubbles for cleaning may be increased, resulting in an increase in filtration costs. One of the measures for reducing filtration costs is to longitudinally join a plurality of filtration modules. However, there is a concern that bubbles may diffuse at holding members of the hollow-fiber membranes (junctions of the filtration modules), and the bubbles may not come into contact with the surfaces of the upper hollow-fiber membranes, resulting in a decrease in cleaning capabilities.

The present invention has been achieved under the circumstances described above. It is an object of the present invention to provide a filtration module and a filtration apparatus, each of which has high efficiency of cleaning the surfaces of hollow-fiber membranes and excellent filtration capability.

### Solution to Problem

According to an aspect of the invention achieved to solve the problem, a filtration module includes a plurality of hollow-fiber membranes held in a state of being arranged in parallel in one direction, and holding members configured to fix both ends of the hollow-fiber membranes, in which the hollow-fiber membranes each include a support layer containing, as a main component, polytetrafluoroethylene and a filtration layer disposed on a surface of the support layer and containing, as a main component, polytetrafluoroethylene; and in which the ratio of the average length to the average outside diameter of the hollow-fiber membranes is 500 to 3,000.

According to another aspect of the invention achieved to solve the problem, a filtration apparatus includes the filtration module and a gas supplying device configured to supply a gas from below the filtration module.

### Advantageous Effects of Invention

The filtration module and the filtration apparatus according to the present invention each have high efficiency of cleaning the surfaces of hollow-fiber membranes and excellent filtration capability. That is, it is possible to reduce the amount of supply of bubbles for cleaning per hollow-fiber membrane, thereby enabling reduction in running costs.

### BRIEF DESCRIPTION OF DRAWINGS

FIG. 1 is a schematic cross-sectional view showing a filtration module according to an embodiment of the present invention,

FIG. 2 is a schematic cross-sectional view showing a hollow-fiber membrane of the filtration module shown in FIG. 1.

FIG. 3a is a schematic plan view showing a lower holding member of the filtration module shown in FIG. 1.

FIG. 3b is a cross-sectional view, taken along the line A-A of FIG. 3a, showing the lower holding member shown in FIG. 3a.

FIG. 4 is a schematic explanatory diagram showing a filtration apparatus according to an embodiment of the present invention.

FIG. 5a is a schematic plan view, taken from above, of a filtration module according to an embodiment different from the filtration module shown in FIG. 1.

FIG. 5b is a cross-sectional view, taken along the line B-B of FIG. 5a, of the filtration module shown in FIG. 5a.

FIG. 6 is a schematic cross-sectional view showing a lower holding member having a different shape from that of the lower holding member shown in FIG. 3b.

FIG. 7 is a schematic plan view showing a lower holding member having a different shape from that of the lower holding member shown in FIG. 3a.

FIG. 8 is a graph showing operation results of Example 1.

FIG. 9 is a graph showing operation results of Example 2.

FIG. 10 is a graph showing operation results of Example 3.

FIG. 11 is a graph showing operation results of Example 4.

FIG. 12 is a graph showing operation results of Example 5.

### DESCRIPTION OF EMBODIMENTS

### [Description of Embodiments of the Present Invention]

The present invention provides a filtration module including a plurality of hollow-fiber membranes held in a state of being arranged in parallel in one direction, and holding members configured to fix both ends of the hollow-fiber membranes, in which the hollow-fiber membranes each include a support layer containing, as a main component, polytetrafluoroethylene and a filtration layer disposed on a surface of the support layer and containing, as a main component, polytetrafluoroethylene; and in which the ratio of the average length to the average outside diameter of the hollow-fiber membranes is 500 to 3,000.

In the filtration module, the aspect ratio, which is the ratio of the average length to the average outside diameter of the hollow-fiber membranes, is equal to or more than the lower limit described above. Consequently, it is possible to increase the surface area of the hollow-fiber membranes scrubbed by one bubble, thereby enabling reduction in cleaning costs for hollow-fiber membranes. That is, when bubbles are supplied so as to flow along the surfaces of the hollow-fiber membranes in the direction in which the hollow-fiber membranes are arranged in parallel, as the average length increases, the surface area of the hollow-fiber membranes scrubbed by bubbles increases. Furthermore, as the average outside diameter (average outer peripheral length) decreases, the contact area between the bubbles and the hollow-fiber membranes is likely to increase. For the reasons described above, by setting the aspect ratio to be equal to or more than the lower limit, the cleaning area per bubble can be increased, and it is possible to markedly reduce the cleaning costs for the hollow-fiber membranes. Furthermore, by setting the aspect ratio to be equal to or less than the upper limit described above, it is possible to prevent a decrease in filtration capability due to an excessive decrease in inside diameter, and occurrence of deflection, a decrease in handleability, and the like due to an excessive increase in length, and filtration capability and efficiency of surface cleaning can be exhibited in a balanced manner.

Furthermore, the present inventors have found that, by setting the aspect ratio of the hollow-fiber membranes to be in the range described above, i.e., by forming relatively elongated hollow-fiber membranes, the hollow-fiber membranes are likely to be vibrated by contact with bubbles, water flow caused by the rising of bubbles, or the like, and the vibration of the hollow-fiber membranes can markedly suppress an increase in the pressure loss of the filtration module. That is, in a commonly used filtration module in which a plurality of hollow-fiber membranes are used, the hollow-fiber membranes are brought into contact with one another by water flow. When impurities are deposited between the hollow-fiber membranes in contact with one another, the surface area of the hollow-fiber membranes is decreased, and the pressure loss of the filtration module tends to increase. In contrast, in the filtration module according to the embodiment of the present invention, by effectively vibrating the hollow-fiber membranes, the hollow-fiber membranes can be separated from one another, and impurities deposited on the surfaces of the hollow-fiber membranes can be removed. Therefore, in the filtration module according to the embodiment, the filtration capability can be maintained at a high level compared with the existing filtration module.

Furthermore, the hollow-fiber membranes of the filtration module according to the embodiment each include a support layer containing, as a main component, polytetrafluoroethylene (PTFE) and a filtration layer also containing, as a main component, PTFE. Therefore, excellent mechanical strength is exhibited. Even if the aspect ratio is high as described above, the amount of deflection is small, and it is possible to prevent damage on the surfaces of the hollow-fiber membranes or the like due to scrubbing with bubbles.

The hollow-fiber membranes may be arranged in parallel in the vertical direction. By arranging the hollow-fiber membranes in parallel in the vertical direction, in the case where the filtration module is combined with a gas supplying device configured to supply bubbles from below, bubbles rise along the surfaces of the hollow-fiber membranes arranged in parallel. Therefore, it is possible to more effectively improve efficiency of cleaning the surfaces of the filtration apparatus.

The average outside diameter of the hollow-fiber membranes is preferably 2 to 6 mm, and the average inside diameter is preferably 0.5 to 4 mm. By setting the average outside diameter and average inside diameter of the hollow-fiber membranes to be in the ranges described above, the mechanical strength of the hollow-fiber membranes and the processing capacity of the filtration module can be exhibited in a balanced manner.

The average length of the hollow-fiber membranes is preferably 3 to 6 m. By setting the average length of the hollow-fiber membranes to be in the range described above, the efficiency of cleaning the surfaces of the hollow-fiber membranes of the filtration module can be more effectively improved while preventing occurrence of deflection of the hollow-fiber membranes or the like.

The ratio of the average inside diameter to the average outside diameter of the hollow-fiber membranes is preferably 0.3 to 0.8. By setting the ratio of the average inside diameter to average outside diameter of the hollow-fiber membranes to be in the range described above, even if the aspect ratio is set to be high as described above, high mechanical strength can be maintained in the longitudinal direction (in the axial direction) of the hollow-fiber membranes, and the effect of improving the efficiency of cleaning of the filtration module can be reliably achieved. Furthermore, particles contained in a liquid to be treated are reliably prevented from permeating through the membranes, and the filtration capability of the filtration module can be further improved.

The tensile strength of the hollow-fiber membranes is preferably 50 N or more. By setting the tensile strength of the hollow-fiber membranes to be equal to or more than the lower limit described above, even if the aspect ratio is set to be high as described above, high mechanical strength can be maintained in the longitudinal direction (in the axial direction) of the hollow-fiber membranes, and the effect of improving the efficiency of cleaning the filtration module can be reliably achieved. Note that the tensile strength means the maximum tensile stress obtained when a tensile test is performed, in accordance with JIS-K7161: 1994, at a gauge length of 100 mm and a testing speed of 100 mm/min.

The density of the hollow-fiber membranes is preferably 4 to 15 membranes/cm². By setting the density of the hollow-fiber membranes to be in the range described above, bubble supply efficiency is improved while maintaining good filtration capability, and the efficiency of cleaning the surfaces of the hollow-fiber membranes of the filtration module can be further improved. Note that the density of the hollow-fiber membranes refers to the value (N/A) obtained by dividing the number N of hollow-fiber membranes in the filtration module by the area A of the region in which the hollow-fiber membranes are arranged. The term “region in which the hollow-fiber membranes are arranged” refers to an imaginary polygon having the smallest area among the imaginary polygons that include all the hollow-fiber membranes in the filtration module when viewed in the axial direction.

The porosity of the hollow-fiber membranes is preferably 75% to 90%. By setting the porosity of the hollow-fiber membranes to be in the range described above, even if the aspect ratio is set to be high as described above, high mechanical strength can be maintained in the longitudinal direction (in the axial direction) of the hollow-fiber membranes while exhibiting high filtration capability, and the effect of improving the efficiency of cleaning the filtration module can be reliably achieved. Note that the porosity refers to the ratio of the total volume of pores to the volume of the hollow-fiber membranes, and is the value obtained by measuring the density of the hollow-fiber membranes in accordance with ASTM-D-792.

The number-average molecular weight of polytetrafluoroethylene, which is a main component of each of the support layer and the filtration layer, is preferably 500,000 to 20,000,000. By setting the number-average molecular weight of PTFE of each of the support layer and the filtration layer to be in the range described above, it is possible to impart mechanical strength and permeability in a balanced manner to the hollow-fiber membranes. Note that the number-average molecular weight is the value measured by gel permeation chromatography.

The filtration layer may be formed by winding a stretched polytetrafluoroethylene sheet around a stretched polytetrafluoroethylene tube constituting the support layer, followed by sintering. By forming a hollow-fiber membrane in such a manner, the shape and size of pores of the hollow-fiber membrane can be easily adjusted, and pores of the support layer and pores of the filtration layer are made to communicate with one another, thus enabling to improve permeability.

In the case where the hollow-fiber membranes are arranged in parallel in the vertical direction, a guide cover which surrounds at least an upper portion of the hollow-fiber membranes may be further provided. By providing the guide cover which surrounds the hollow-fiber membranes in such a manner, bubbles for cleaning can be prevented from dispersing as they rise, and the rising speed of bubbles can be improved. Consequently, the efficiency of cleaning the surfaces of hollow-fiber membranes and the vibration effect can be further improved.

Accordingly, in a filtration apparatus which includes the filtration module and a gas supplying device configured to supply a gas from below the filtration module, the surfaces of the hollow-fiber membranes can be efficiently cleaned, and high processing capacity can be achieved at low running costs.

### [Detailed Description of Embodiments of the Present Invention]

Embodiments of the filtration module and the filtration apparatus according to the present invention will be described in detail with reference to the drawings.

### First Embodiment

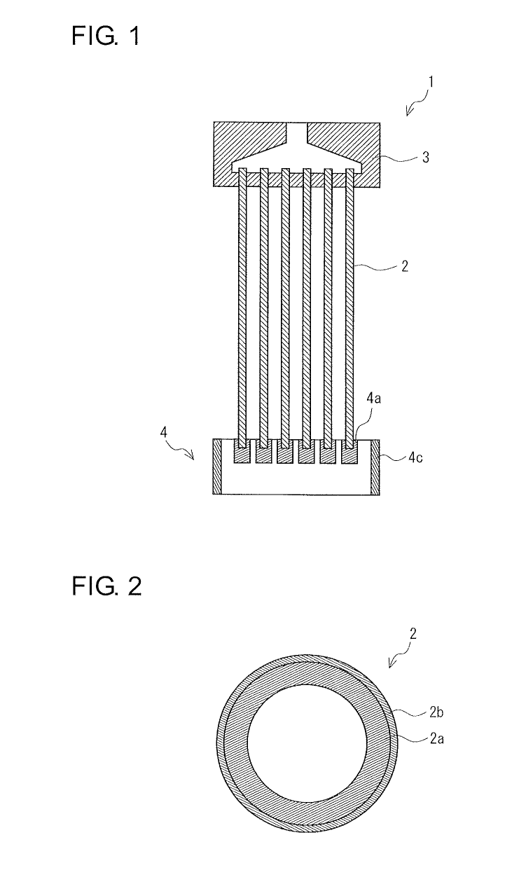

A filtration module 1 shown in FIG. 1 includes a plurality of hollow-fiber membranes 2 arranged in parallel in the vertical direction, and an upper holding member 3 and a lower holding member 4 which are configured to fix both ends of the hollow-fiber membranes 2.

### (Hollow-Fiber Membrane)

The hollow-fiber membranes 2 are each a porous hollow-fiber membrane which allows water to pass through a hollow portion inside thereof, and which prevents permeation of particles contained in a liquid to be treated.

As shown in FIG. 2, a hollow-fiber membrane 2 includes a cylindrical support layer 2a and a filtration layer 2b disposed on a surface of the support layer 2a. By forming the hollow-fiber membrane 2 so as to have such a multilayer structure, both permeability and mechanical strength can be achieved, and the effect of surface cleaning with bubbles can be enhanced.

The support layer 2a and the filtration layer 2b are each composed of a material containing, as a main component, polytetrafluoroethylene (PTFE). Other polymers, additives, such as a lubricant, and the like may be appropriately added to the material for each of the support layer 2a and the filtration layer 2b.

The lower limit of the number-average molecular weight of PTFE of each of the support layer 2a and the filtration layer 2b is preferably 500,000, and more preferably 2,000,000. When the number-average molecular weight of PTFE is less than the lower limit, there is a concern that the surfaces of the hollow-fiber membranes 2 may be damaged by scrubbing with bubbles, or the mechanical strength of the hollow-fiber membranes 2 may be decreased. On the other hand, the upper limit of the number-average molecular weight of PTFE of each of the support layer 2a and the filtration layer 2b is preferably 20,000,000. When the number-average molecular weight of PTFE is more than the upper limit, there is a concern that formation of pores of the hollow-fiber membranes 2 may become difficult.

As the support layer 2a, for example, a tube obtained by extrusion of PTFE may be used. By using an extruded tube as the support layer 2a, mechanical strength can be imparted to the support layer 2a and pores can be formed easily. Preferably, the tube is stretched at a stretching ratio of 50% to 700% in the axial direction and at a stretching ratio of 5% to 100% in the circumferential direction.

The stretching is preferably performed at a temperature that is equal to or lower than the melting point of the tube material, for example, at about 0° C. to 300° C. In order to obtain a porous body having a relatively large pore diameter, stretching may be performed at a low temperature. In order to obtain a porous body having a relatively small pore diameter, stretching may be performed at a high temperature. By performing heat treatment, at a temperature of 200° C. to 300° C. for 1 to 30 minutes, on the stretched porous body while maintaining the stretched state by fixing both ends, high dimensional stability can be obtained. Furthermore, by combining the conditions, such as the stretching temperature and the stretching ratio, it is possible to adjust the size of pores of the porous body.

The tube constituting the support layer 2a can be obtained, for example, by blending PTFE fine powder with a liquid lubricant, such as naphtha, and forming the resulting mixture into a tube shape by extrusion or the like, followed by stretching. Furthermore, by holding and sintering the tube in a heating furnace which is maintained at a temperature equal to or higher than the melting point of the PTFE fine powder, for example, about 350° C. to 550° C., dimensional stability can be enhanced.

The average thickness of the support layer 2a is preferably 0.1 to 3 mm. By setting the average thickness of the support layer 2a to be in the range described above, mechanical strength and permeability can be imparted to the hollow-fiber membrane 2 in a balanced manner.

The filtration layer 2b can be formed, for example, by winding a PTFE sheet around the support layer 2a, followed by sintering. By using a sheet as the material for the filtration layer 2b, stretching can be easily performed, adjustment of the shape and size of pores is facilitated, and the thickness of the filtration layer 2b can be decreased. Furthermore, by performing sintering with the sheet being wound, the support layer 2a and the filtration layer 2b are integrated, and pores of both layers are made to communicate with one another, thus enabling to improve permeability. The sintering temperature is preferably equal to or higher than the melting point of each of the tube constituting the support layer 2a and the sheet constituting the filtration layer 2b.

The sheet constituting the filtration layer 2b can be formed, for example, by using (1) a method in which an unsintered shaped body obtained by extrusion of a resin is stretched at a temperature equal to or lower than the melting point, followed by sintering, or (2) a method in which a sintered resin shaped body is slowly cooled to enhance the crystallinity, and then stretching is performed. Preferably, the sheet is stretched at a stretching ratio of 50% to 1,000% in the longitudinal direction and at a stretching ratio of 50% to 2,500% in the lateral direction. In particular, by setting the stretching ratio in the lateral direction to be in the range described above, mechanical strength in the circumferential direction can be improved when the sheet is wound around the tube, and durability against surface cleaning with bubbles can be improved.

Furthermore, in the case where the filtration layer 2b is formed by winding a sheet around the tube constituting the support layer 2a, fine irregularities may be provided on the outer peripheral surface of the tube. By providing irregularities on the outer peripheral surface of the tube, misalignment with the sheet can be prevented, and adhesion between the tube and the sheet is improved, thus preventing the filtration layer 2b from being peeled off from the support layer 2a by cleaning with bubbles. The number of turns of the sheet can be adjusted depending on the thickness of the sheet, and may be set to one or more. Furthermore, a plurality of sheets may be wound around the tube. The method of winding the sheet around the tube is not particularly limited, and the sheet may be wound in the circumferential direction of the tube, or may be spirally wound.

The size (difference in height) of the fine irregularities is preferably 20 to 200 μm. The fine irregularities are preferably formed over the entire outer peripheral surface of the tube, but may be formed partially or discontinuously. As the method of forming the fine irregularities on the outer peripheral surface of the tube, for example, flame surface treatment, laser irradiation, plasma irradiation, or dispersion coating of a fluororesin or the like may be used. Flame surface treatment, in which irregularities can be easily formed without affecting tube properties, is preferable.

Furthermore, a method may be used in which an unsintered tube and an unsintered sheet are used, and after winding the sheet around the tube, sintering is performed, thereby enhancing adhesion thereof.

The average thickness of the filtration layer 2b is preferably 5 to 100 μm. By setting the average thickness of the filtration layer 2b to be in the range described above, it is possible to impart high filtration performance to the hollow-fiber membrane 2 easily and reliably.

The upper limit of the average outside diameter of the hollow-fiber membranes 2 is preferably 6 mm, and more preferably 4 mm. When the average outside diameter of the hollow-fiber membranes 2 is more than the upper limit, the ratio of the surface area to the cross-sectional area of the hollow-fiber membranes 2 is decreased, which may result in a decrease in filtration efficiency. Furthermore, there is a concern that the surface area scrubbed with one bubble may be decreased. On the other hand, the lower limit of the average outside diameter of the hollow-fiber membranes 2 is preferably 2 mm, and more preferably 2.1 mm. When the average outside diameter of the hollow-fiber membranes 2 is less than the lower limit, there is a concern that the mechanical strength of the hollow-fiber membranes 2 may become insufficient.

The upper limit of the average inside diameter of the hollow-fiber membranes 2 is preferably 4 mm, and more preferably 3 mm. When the average inside diameter of the hollow-fiber membranes 2 is more than the upper limit, the thickness of the hollow-fiber membrane 2 is decreased, and there is a concern that mechanical strength and the effect of preventing permeation of impurities may become insufficient. On the other hand, the lower limit of the average inside diameter of the hollow-fiber membranes 2 is preferably 0.5 mm, and more preferably 0.9 mm. When the average inside diameter of the hollow-fiber membranes 2 is less than the lower limit, there is a concern that the pressure loss may increase at the time of discharging of the filtrate inside the hollow-fiber membranes 2.

The upper limit of the ratio of the average inside diameter to the average outside diameter of the hollow-fiber membranes 2 is preferably 0.8, and more preferably 0.6. When the ratio of the average inside diameter to the average outside diameter of the hollow-fiber membranes 2 is more than the upper limit, the thickness of the hollow-fiber membranes 2 decreases, and there is a concern that mechanical strength and the effect of preventing permeation of impurities may become insufficient. On the other hand, the lower limit of the ratio of the average inside diameter to the average outside diameter of the hollow-fiber membranes 2 is preferably 0.3, and more preferably 0.4. When the ratio of the average inside diameter to the average outside diameter of the hollow-fiber membranes 2 is less than the lower limit, the thickness of the hollow-fiber membranes 2 increases more than necessary, and there is a concern that permeability of the hollow-fiber membranes 2 may be decreased.

The lower limit of the average length of the hollow-fiber membranes 2 is preferably 3 m, and more preferably 3.5 m. When the average length of the hollow-fiber membranes 2 is less than the lower limit, the surface area of the hollow-fiber membranes 2 scrubbed with one bubble supplied from below the filtration module 1 during the period in which the bubble rises to the water surface, and there is a concern that efficiency of cleaning of the hollow-fiber membranes 2 may be decreased. There is also a concern that vibration of the hollow-fiber membranes 2 may not occur satisfactorily. On the other hand, the upper limit of the average length of the hollow-fiber membranes 2 is preferably 6 m, and more preferably 5.5 m. When the average length of the hollow-fiber membranes 2 is more than the upper limit, there is a concern that deflection of the hollow-fiber membranes 2 may be increased excessively by their own weight, and there is a concern that handleability may be decreased during installation of the filtration module 1 or the like. Note that the average length of the hollow-fiber membranes 2 refers to the average distance from the top end at which the hollow-fiber membranes 2 are fixed to the upper holding member 3 to the bottom end at which the hollow-fiber membranes 2 are fixed to the lower holding member 4. In the case where hollow-fiber membranes 2 are each bent in a U-shape and the curved portion thereof, as the bottom end, is fixed by the lower holding member 4 as will be described later, the average length of the hollow-fiber membranes 2 refers to the average distance from the bottom end to the top end (opening).

The lower limit of the ratio of the average length to the average outside diameter (aspect ratio) of the hollow-fiber membranes 2 is 500, and preferably 1,000. When the aspect ratio of the hollow-fiber membranes 2 is less than the lower limit, the surface area of the hollow-fiber membranes 2 that can be scrubbed with one bubble decreases, and therefore there is a concern that efficiency of cleaning the hollow-fiber membranes 2 may be decreased. There is also a concern that vibration of the hollow-fiber membranes 2 may not occur satisfactorily. On the other hand, the upper limit of the aspect ratio of the hollow-fiber membranes 2 is 3,000, and preferably 2,500. When the aspect ratio of the hollow-fiber membranes 2 is more than the upper limit, the hollow-fiber membranes 2 are excessively elongated, and therefore there is a concern that mechanical strength may be decreased when the hollow-fiber membranes 2 are arranged in parallel in the vertical direction.

The upper limit of the porosity of the hollow-fiber membranes 2 is preferably 90%, and more preferably 85%. When the porosity of the hollow-fiber membranes 2 is more than the upper limit, there is a concern that mechanical strength and resistance to scrubbing of the hollow-fiber membranes 2 may become unsatisfactory. On the other hand, the lower limit of the porosity of the hollow-fiber membranes 2 is preferably 75%, and more preferably 78%. When the porosity of the hollow-fiber membranes 2 is less than the lower limit, permeability decreases, and there is a concern that the filtration capability of the filtration module 1 may be decreased.

The upper limit of the area fraction of pores in the hollow-fiber membrane 2 is preferably 60%. When the area fraction of pores is more than the upper limit, the surface strength of the hollow-fiber membrane 2 becomes insufficient, and there is a concern that the hollow-fiber membrane 2 may be damaged by scrubbing with bubbles. On the other hand, the lower limit of the area fraction of pores in the hollow-fiber membrane 2 is preferably 40%. When the area fraction of pores is less than the lower limit, permeability decreases, and there is a concern that the filtration capability of the filtration module 1 may be decreased. Note that the area fraction of pores refers to the ratio of the total area of pores in the outer peripheral surface (surface of the filtration layer) of the hollow-fiber membrane 2 to the surface area of the hollow-fiber membrane 2 and can be determined by analyzing an electron micrograph of the outer peripheral surface of the hollow-fiber membrane 2.

The upper limit of the mean pore diameter of the hollow-fiber membranes 2 is preferably 0.45 μm, and more preferably 0.1 μm. When the mean pore diameter of the hollow-fiber membranes 2 is more than the upper limit, there is a concern that it may not be possible to prevent impurities contained in a liquid to be treated from permeating into the hollow-fiber membranes 2. On the other hand, the lower limit of the mean pore diameter of the hollow-fiber membranes 2 is preferably 0.01 μm. When the mean pore diameter of the hollow-fiber membranes 2 is less than the lower limit, there is a concern that permeability may be decreased. Note that the mean pore diameter refers to the mean diameter of pores of the outer peripheral surface (surface of the filtration layer) and can be measured by a pore diameter distribution measuring apparatus (e.g., automated pore diameter distribution measuring system for porous materials, manufactured by Porus Materials, Inc).

The lower limit of the tensile strength of the hollow-fiber membranes 2 is preferably 50 N, and more preferably 60 N. When the tensile strength of the hollow-fiber membranes 2 is less than the lower limit, there is a concern that durability against surface cleaning with bubbles may be degraded. Note that the upper limit of the tensile strength of the hollow-fiber membranes 2 is generally 150 N.

### (Upper Holding Member and Lower Holding Member)

The upper holding member 3 is configured to hold the top ends of a plurality of hollow-fiber membranes 2, communicates with upper openings of the hollow-fiber membranes 2, and includes a discharging portion (water-collecting header) that collects the filtrate. An discharge pipe is connected to the discharging portion so as to discharge the filtrate that has been permeated into the hollow-fiber membranes 2. The shape of the upper holding member 3 is not particularly limited, and the cross-sectional shape thereof may be polygonal, circular, or the like.

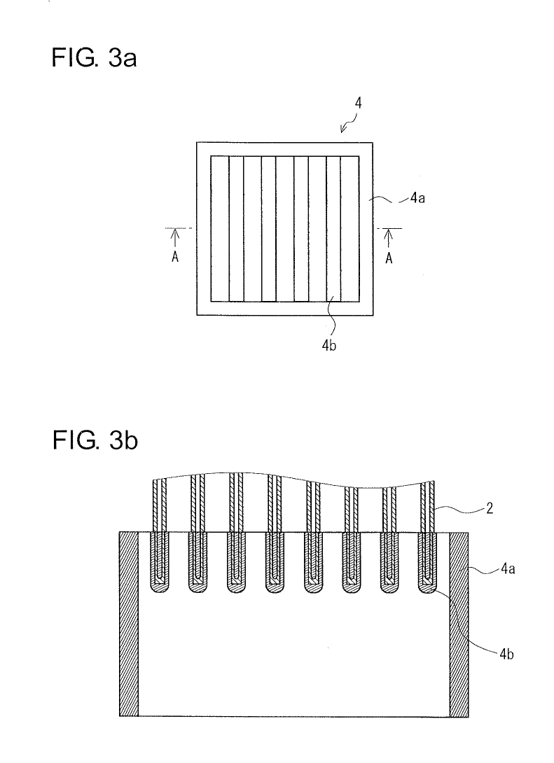

The lower holding member 4 is configured to hold the bottom ends of a plurality of hollow-fiber membranes 2. As shown in FIGS. 3a and 3b, the lower holding member 4 includes an outer frame 4a and a plurality of fixing portions 4b which fix the bottom ends of the hollow-fiber membranes 2. The fixing portions 4b are, for example, bar-shaped and arranged substantially in parallel at certain intervals. The hollow-fiber membranes 2 are disposed on the upper side of the fixing portions 4b.

Both ends of one hollow-fiber membrane 2 may be fixed with the upper holding member 3 and the lower holding member 4. Alternatively, one hollow-fiber membrane 2 may be bent in a U-shape, two openings may be fixed with the upper holding member 3, and a folded (curved) portion at the bottom end may be fixed with the lower holding member 4.

The outer frame 4a is configured to support the fixing portions 4b. The length of one side of the outer frame 4a can be set, for example, to be 50 to 200 mm. Furthermore, the cross-sectional shape of the outer frame 4a is not particularly limited, and may be polygonal or circular, other than the rectangular shape shown in FIG. 3a.

Bubbles supplied from a gas supplying device 5, which will be described later, pass through the spaces between the fixing portions 4b and move upward while scrubbing the surfaces of the hollow-fiber membranes 2.

The width (length in the lateral direction) of the fixing portions 4b and the spaces therebetween are not particularly limited as long as a sufficient number of hollow-fiber membranes 2 can be fixed, and bubbles supplied from the gas supplying device 5 can pass therethrough. The width of the fixing portion 4b can be set, for example, to be 3 to 10 mm. The space between the fixing portions 4b can be set, for example, to be 1 to 10 mm.

The upper limit of the density (N/A) of the hollow-fiber membranes 2, which is obtained by dividing the number N of hollow-fiber membranes 2 held by the lower holding member 4 by the area A of the region in which the hollow-fiber membranes 2 are arranged, is preferably 15 membranes/cm², and more preferably 12 membranes/cm². When the density of the hollow-fiber membranes 2 is more than the upper limit, the distance between the hollow-fiber membranes 2 is decreased, and there is a concern that it may not be possible to clean the surfaces satisfactorily, or there is a concern that vibration of the hollow-fiber membranes 2 may not occur satisfactorily. On the other hand, the lower limit of the density of the hollow-fiber membranes 2 is preferably 4 membranes/cm², and more preferably 6 membranes/cm². When the density of the hollow-fiber membranes 2 is less than the lower limit, there is a concern that the filtration efficiency per unit volume of the filtration module 1 may be decreased.

Furthermore, assuming that the hollow-fiber membranes 2 are solid, the upper limit of the area fraction (S/A) of the hollow-fiber membranes 2 obtained by dividing the sum S of cross-sectional areas of the hollow-fiber membranes 2 held by the lower holding member 4 by the area A of the region in which the hollow-fiber membranes 2 are arranged is preferably 60%, and more preferably 55%. When the area fraction of the hollow-fiber membranes 2 is more than the upper limit, the distance between the hollow-fiber membranes 2 is decreased, and there is a concern that it may not be possible to clean the surfaces satisfactorily. On the other hand, the lower limit of the area fraction of the hollow-fiber membranes 2 is preferably 20%, and more preferably 25%. When the area fraction of the hollow-fiber membranes 2 is less than the lower limit, there is a concern that the filtration efficiency per unit volume of the filtration module 1 may be decreased.

The material for each of the upper holding member 3 and the lower holding member 4 is not particularly limited, and for example, an epoxy resin, an ABS resin, a silicone resin, or the like can be used.

The method for fixing the hollow-fiber membranes 2 to each of the upper holding member 3 and the lower holding member 4 is not particularly limited, and for example, a method in which fixing is performed using an adhesive may be employed.

Furthermore, in order to facilitate handling (transport, installation, replacement, etc.) of the filtration module 1, preferably, the upper holding member 3 and the lower holding member 4 are joined with each other by a joining member. As the joining member, for example, a supporting bar made of metal, a casing (external cylinder) made of resin, or the like can be used.

### <Advantages>

In the filtration module 1, since the aspect ratio, which is the ratio of the average length to the average outside diameter of the hollow-fiber membranes 2, is a certain value or more, it is possible to increase the surface area of the hollow-fiber membranes 2 scrubbed with one bubble, thereby enabling reduction in cleaning costs. That is, since bubbles supplied from below the filtration module 1 rise along the surfaces of the hollow-fiber membranes 2, as the average length increases, the surface area of the hollow-fiber membranes 2 scrubbed with bubbles increases. Furthermore, as the average outside diameter (average outer peripheral length) decreases, the curvature of the surfaces of the hollow-fiber membranes 2 increases, and the contact area between the bubbles and the hollow-fiber membranes 2 is likely to increase. For the reasons described above, by setting the aspect ratio to be the certain value or more, the cleaning area per bubble can be increased, and it is possible to markedly reduce the cleaning costs for the hollow-fiber membranes 2.

Furthermore, in the filtration module 1, by setting the aspect ratio of the hollow-fiber membranes 2 to be in a certain range, the hollow-fiber membranes are easily vibrated by upward pressure of bubbles. In the filtration module 1, by effectively vibrating the hollow-fiber membranes 2 in such a manner, the hollow-fiber membranes 2 can be separated from one another, and impurities deposited on the surfaces of the hollow-fiber membranes 2 can be removed.

Furthermore, since the hollow-fiber membranes 2 of the filtration module 1 each include the support layer 2a containing, as a main component, polytetrafluoroethylene (PTFE) and the filtration layer 2b also containing, as a main component, PTFE, excellent mechanical strength is exhibited. Even if the aspect ratio is high as described above, the amount of deflection is small, and it is possible to prevent damage on the surfaces of the hollow-fiber membranes 2 due to scrubbing with bubbles. Furthermore, by setting the aspect ratio to be a certain value or less, it is possible to prevent a decrease in filtration capability due to an excessive decrease in inside diameter, and occurrence of deflection, a decrease in handleability, and the like due to an excessive increase in length, and filtration capability and efficiency of surface cleaning can be achieved in a balanced manner.

Furthermore, in the filtration module 1, since the lower holding member 4 has a plurality of fixing portions 4b, bubbles pass through the spaces between the fixing portions 4b and rise in close vicinity of the hollow-fiber membranes 2. Therefore, it is possible to increase the surface area of the hollow-fiber membranes 2 scrubbed with bubbles, and as a result, synergistically with the fact that the aspect ratio is a certain value or more, efficiency of cleaning can be effectively improved.

### <Filtration Apparatus>

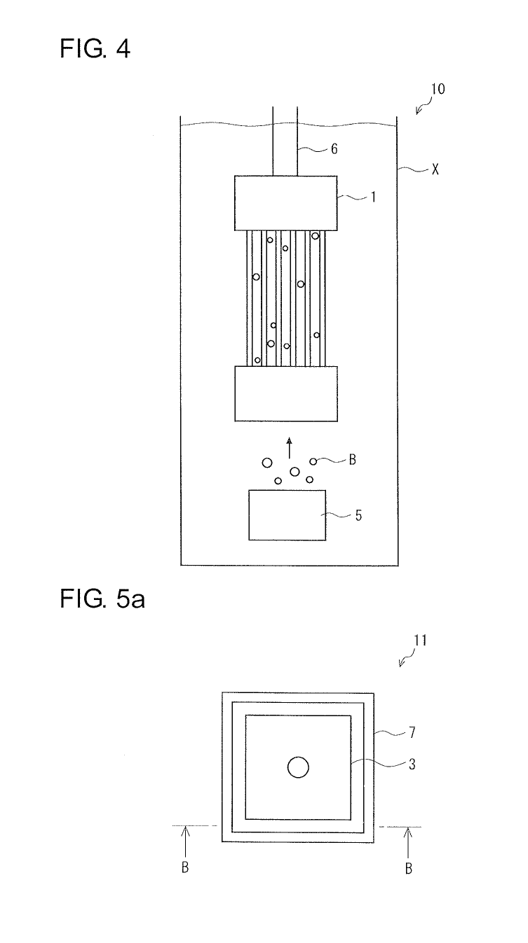

A filtration apparatus 10 shown in FIG. 4 includes the filtration module 1 and a gas supplying device 5 configured to supply a gas from below the filtration module 1, and is used while being immersed in a filtration tank X in which a liquid to be treated is stored. A discharge pipe 6 is connected to the discharging portion of the upper holding member 3 of the filtration module 1, and a filtrate is discharged.

The gas supplying device 5 supplies bubbles B for cleaning the surfaces of the hollow-fiber membranes 2 from below the filtration module 1. The bubbles B pass through the spaces between the fixing portions 4b and rise while scrubbing the surfaces of the hollow-fiber membranes 2, and thus the surfaces of the hollow-fiber membranes 2 are cleaned.

The gas supplying device 5 is, together with the filtration module 1, immersed in the filtration tank X in which a liquid to be treated is stored, and supplies bubbles B by continuously or intermittently ejecting a gas supplied from a compressor or the like through an air supply pipe (not shown). Such a gas supplying device 5 is not particularly limited, and a known air-diffusing device can be used. Examples of the air-diffusing device include an air-diffusing device which uses a porous plate or porous tube obtained by forming many pores in a plate or tube made of resin or ceramic, a jet-type air-diffusing device in which a gas is jetted from a diffuser or sparger, and an intermittent bubble-jet-type air-diffusing device which jets bubbles intermittently. Examples of the intermittent bubble-jet-type air-diffusing device include a pump in which a gas continuously supplied from a compressor or the like through an air supply pipe (not shown) is stored inside thereof, and bubbles are supplied by intermittently ejecting the gas whose volume has reached a certain value. By intermittently jetting large bubbles toward the hollow-fiber membranes 2 using such a pump, bubbles are divided by the lower holding member 4 and rise while being in contact with the surfaces of the hollow-fiber membranes 2. The divided bubbles have a mean diameter that is close to the space between the hollow-fiber membranes 2, and are likely to diffuse uniformly between the hollow-fiber membranes 2. Therefore, the bubbles vibrate the hollow-fiber membranes 2 effectively, and it is possible to further enhance the efficiency of cleaning the hollow-fiber membranes 2.

Note that the gas supplied from the gas supplying device 5 is not particularly limited as long as it is inert, but use of air is preferable from the standpoint of running costs.

Furthermore, the filtration apparatus 10 may include a plurality of filtration modules 1. In the case where the filtration apparatus 10 includes a plurality of filtration modules 1, gas supplying devices 5 may be arranged below the corresponding filtration modules 1, or a gas supplying device 5 capable to supply bubbles to the filtration modules 1 may be arranged.

### <Usage>

The filtration apparatus 10 can be used by being immersed in a filtration tank in which a liquid to be treated, to be filtered, is stored. Examples of specific use of the filtration apparatus 10 include sewage and effluent treatment, industrial effluent treatment, filtration of tap water for industrial use, treatment of cleaning water for machines and the like, filtration of pool water, filtration of river water, filtration of seawater, sterilization or clarification in fermentation processes (enzyme or amino acid purification), filtration of food, sake, beer, wine, and the like (in particular, raw products), separation of bacterial cells from fermenters in pharmaceutical manufacturing and the like, filtration of water and dissolved dye in the dyeing industry, culture filtration of animal cells, pretreatment filtration in pure water production processes using RO membranes (including desalination of seawater), pretreatment filtration in processes using ion-exchange membranes, pretreatment filtration in pure water production processes using ion-exchange resins, and the like.

In water purification treatment, the filtration apparatus 10 can be used in combination with powdered activated carbon. First, very small dissolved organic substances are adsorbed by powdered activated carbon, and by filtering water containing the powdered activated carbon which has adsorbed the dissolved organic substances using the filtration apparatus 10, water purification treatment can be performed efficiently.

In sewage treatment, the filtration apparatus 10 can be used in combination with a tank in which bacterial cells are propagated. Sewage is introduced into the tank, and after bacterial cells clean the sewage by decomposing polluting components in the sewage, the sewage containing the bacterial cells is filtered with the filtration apparatus 10. Thus, sewage treatment can be performed efficiently.

### Second Embodiment

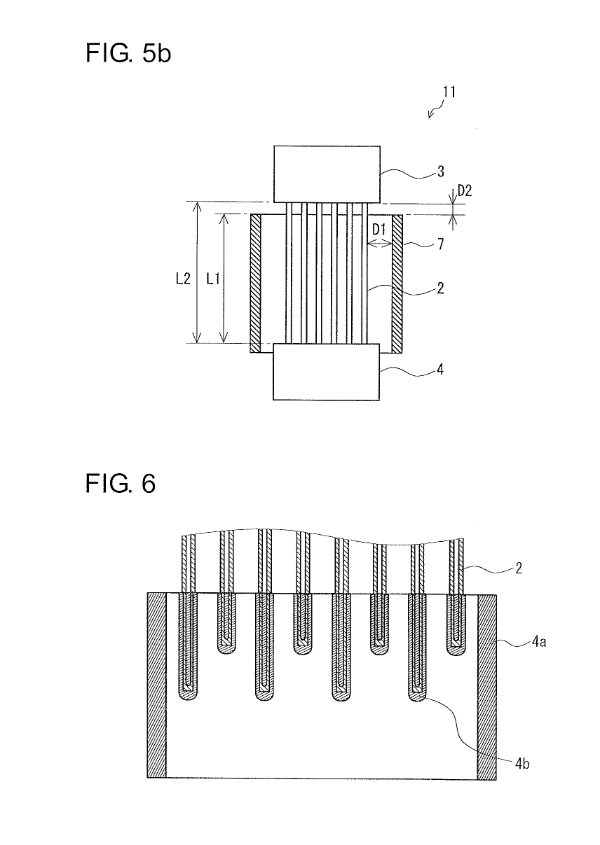

A filtration module 11 shown in FIGS. 5a and 5b includes a plurality of hollow-fiber membranes 2 arranged in parallel in the vertical direction, an upper holding member 3 and a lower holding member 4 which are configured to fix both ends of the hollow-fiber membranes 2, and a guide cover 7 which surrounds the hollow-fiber membranes 2. Since the hollow-fiber membranes 2, the upper holding member 3, and the lower holding member 4 are the same as those of the first embodiment, they are denoted by the same reference signs, and description thereof is omitted.

### (Guide Cover)

The guide cover 7 is a tubular body that surrounds the hollow-fiber membranes 2. The guide cover 7 surrounds at least the upper portion of the hollow-fiber membranes 2 such that bubbles for cleaning do not disperse at the upper side of the filtration module 11.

The guide cover 7 is preferably disposed at a distance from the upper holding member 3 in the vertical direction. That is, preferably, the guide cover 7 does not surround the upper holding member 3 and a space is formed between the two. By placing the guide cover 7 at a distance from the upper holding member 3 in such a manner, it is possible to release impurities (residue) separated from the hollow-fiber membranes 2 by bubbles from the space between the guide cover 7 and the upper holding member 3 to the outside of the filtration module 11, thus enabling improvement in the cleaning effect. On the other hand, the guide cover 7 preferably surrounds a portion of the lower holding member 4.

The lower limit of the length L1 of the surrounding region in which the guide cover 7 surrounds the hollow-fiber membranes 2 in the vertical direction is preferably 30%, more preferably 50%, and still more preferably 80% of the average distance L2 between the upper holding member 3 and the lower holding member 4. On the other hand, the upper limit of the length L1 of the surrounding region is preferably 100%, more preferably 98%, and still more preferably 95% of the average distance L2 between the upper holding member 3 and the lower holding member 4. When the length L1 of the surrounding region is less than the lower limit, there is a concern that the effect of preventing dispersion of bubbles B′ and the effect of improving the rising speed may become insufficient. On the other hand, when the length L1 of the surrounding region is more than the upper limit, impurities separated from the hollow-fiber membranes 2 are unlikely to be released to the outside of the filtration module 11, and there is a concern that the cleaning effect may not be improved sufficiently.

The lower limit of the average distance D1 between the inner surface of the guide cover 7 and the hollow-fiber membrane 2 adjacent to the guide cover 7 is preferably 20 mm, more preferably 30 mm, and still more preferably 40 mm. On the other hand, the upper limit of the average distance D1 is preferably 400 mm, more preferably 250 mm, and still more preferably 100 mm. When the average distance D1 is more than the upper limit, there is a concern that the effect of preventing dispersion of bubbles may become insufficient. On the other hand, when the average distance D1 is less than the lower limit, the hollow-fiber membrane 2 and the guide cover 7 are brought into contact with each other, and there is a concern that cleaning and vibration of the hollow-fiber membranes 2 may become insufficient or the surface of the hollow-fiber membranes 2 may be worn.

The distance D2 in the vertical direction between the guide cover 7 and the upper holding member 3 can be set, for example, to be 50 to 200 mm.

The bottom shape of the guide cover 7 is not limited to the rectangular shape shown in FIG. 5a, but can be appropriately designed depending on the shapes of the upper holding member 3 and the lower holding member 4, the arrangement of the hollow-fiber membranes 2, or the like. The bottom shape may be circular, or polygonal other than rectangular.

As the material for the guide cover 7, for example, the same resin as that for each of the upper holding member 3 and the lower holding member 4, a vinyl chloride resin, stainless steel, or the like can be used.

### <Advantages>

Since the filtration module 11 includes the guide cover 7 which surrounds the hollow-fiber membranes 2, bubbles for cleaning can be prevented from dispersing as they rise, and the rising speed of bubbles can be improved. Therefore, the filtration module 11 is excellent particularly in terms of the efficiency of cleaning the surfaces of hollow-fiber membranes 2 and the vibration effect.

### Other Embodiments

It is to be understood that the embodiments disclosed this time are illustrative in all aspects and not restrictive. It is intended that the scope of the present invention is not limited to the embodiments described above, but is determined by appended claims, and includes all variations of the equivalent meanings and ranges to the claims.

In the embodiments, the lower holding member includes bar-shaped fixing portions which hold a plurality of hollow-fiber membranes. However, the present invention is not limited thereto. That is, for example, it is also possible to configure such that a fixing portion holds a hollow-fiber membrane, and a plurality of fixing portions are arranged with a space therebetween.

Furthermore, as shown in FIG. 6, the adjacent fixing portions 4b may be arranged at positions different in the vertical direction. By arranging the adjacent fixing portions 4b at different levels, dispersibility of bubbles for each hollow-fiber membrane 2 can be improved.

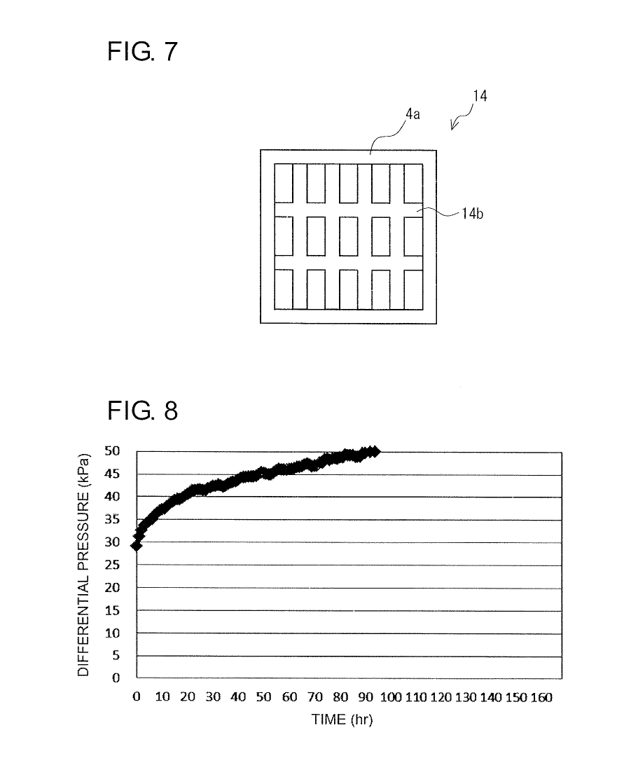

Furthermore, in the embodiments described above, the fixing portions are arranged with a space therebetween. However, the present invention is not limited thereto. For example, in the case where a fixing portion is a plate-like body without a space between fixing portions, the manufacturing costs of the filtration module can be reduced. However, in order to improve the capability of cleaning the surfaces of the hollow-fiber membranes, preferably, a space is provided between fixing portions or between the fixing portion and the outer flame. Furthermore, in the case where the fixing portions are arranged with a space therebetween as in the embodiments described above, the structure is not limited to that of the embodiments. That is, for example, as in a lower holding member 14 shown in FIG. 7, a plate-like fixing portion 14b may be provided with a plurality of through-holes.

Furthermore, the filtration module may include, in a guide cover, a plurality of upper holding members and lower holding members, and hollow-fiber membranes held by these holding members.

Furthermore, the filtration module may have a structure in which both ends of a plurality of hollow-fiber membranes are fixed by an upper holding member and a lower holding member, and by connecting a discharge pipe to each of the upper holding member and the lower holding member, water is collected from both ends of the hollow-fiber membranes. By collecting water from both ends of the hollow-fiber membranes in such a manner, in comparison to the case where water is collected from one end, the pipe resistance in the hollow-fiber membranes can be reduced to ⅛, thus enabling improvement in water-collecting efficiency. In the case where water is collected from both ends, the lower holding member may be formed into the planar shape shown in FIG. 3a, a water-collecting path may be provided in each of a plurality of fixing portions 4b, and water may be collected from the side surface of the lower holding member 4 using a discharge pipe. In this case, a space where bubbles can pass through can be provided on the lower surface of the lower holding member, and bubbles supplied from the gas supplying device can be efficiently sent to the hollow-fiber membranes as in the embodiments described above.

Furthermore, the direction in which the hollow-fiber membranes of the filtration module are arranged in parallel is not limited to the vertical direction, but may be the horizontal direction, or an oblique direction. In the case where the direction in which the hollow-fiber membranes are arranged in parallel is not the vertical direction, for example, by jetting bubbles in the direction in which the hollow-fiber membranes are arranged in parallel, or by forming a water flow in the direction substantially the same as the direction in which the hollow-fiber membranes are arranged in parallel to supply bubbles, bubbles are made to scrub the surfaces of the hollow-fiber membranes.

Furthermore, it is possible to apply the filtration module to an external pressure-type filtration apparatus, and even when used for the external pressure-type, the effects of the present invention can be achieved.

### EXAMPLES

The present invention will be described in more detail below on the basis of examples. However, it is to be understood that the present invention is not limited to the examples.

### Example 1

Using a filtration module shown in FIG. 1, a liquid to be treated (sludge water) was subjected to a filtration process at a processing speed of 0.7 m³/m²·day, and a change in differential pressure between the inside and outside of hollow-fiber membranes was measured during the filtration process. The average length of the hollow-fiber membranes was 3.2 m, the average outside diameter was 2.3 mm, and the average inside diameter was 1.1 mm. The number of hollow-fiber membranes was 740. Furthermore, in the filtration process, bubbles for cleaning were continuously supplied at 50 L/mm by an air-diffusing device using a porous tube, and 9-minute operation and 1-minute stop were repeated. The results thereof are shown in FIG. 8.

### Example 2

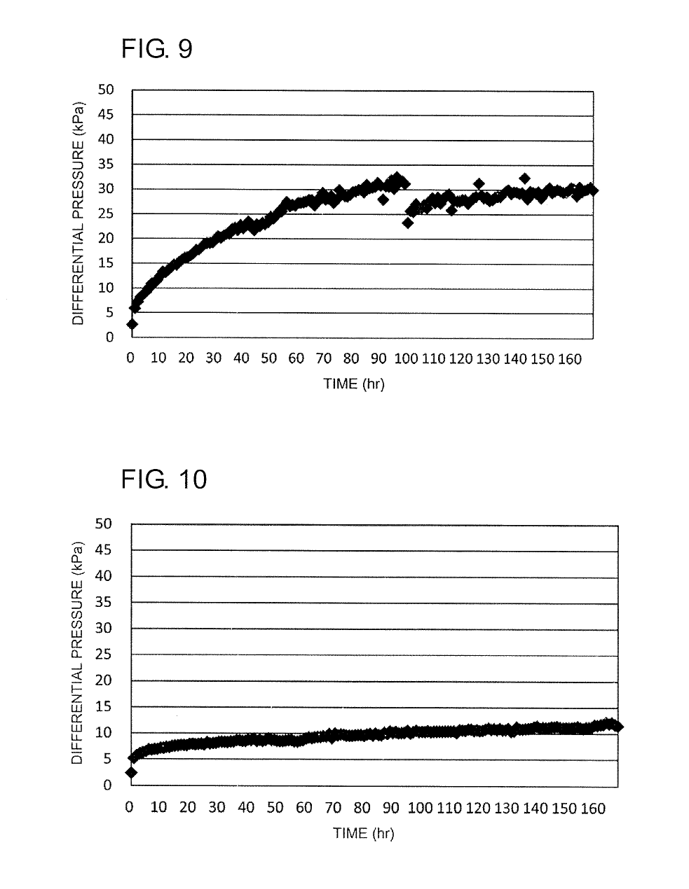

A filtration process was performed under the same conditions as in Example 1, using the filtration module of Example 1 on which a guide cover was provided (filtration module shown in FIGS. 5a and 5b), and a change in differential pressure between the inside and outside of hollow-fiber membranes was measured during the filtration process. The length of the guide cover was 3.7 m, and the guide cover surrounded the hollow-fiber membranes, the upper holding member, and the lower holding member entirely in the vertical direction. The results thereof are shown in FIG. 9.

### Example 3

A filtration process was performed under the same conditions as in Example 1 except that the filtration module of Example 2 was used, and bubbles were intermittently supplied by an intermittent bubble-jet-type air-diffusing device (intermittent pump) with the same amount of supply as that in Example 1 so that bubbles were divided by the lower holding member. A change in differential pressure between the inside and outside of hollow-fiber membranes was measured during the filtration process. The results thereof are shown in FIG. 10.

### Example 4

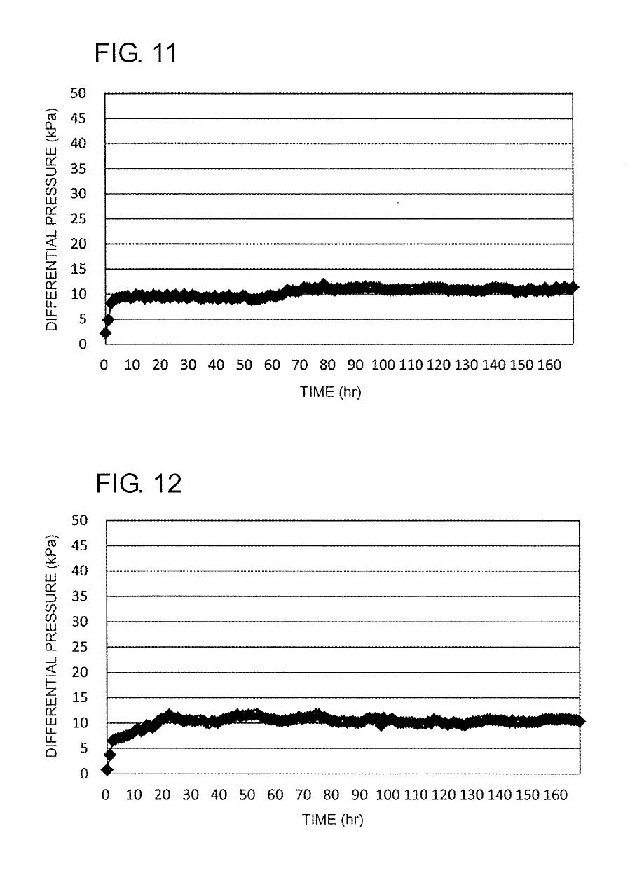

Using a filtration module provided with a guide cover which had the same structure as that in Example 2 except that both ends of a plurality of hollow-fiber membranes were fixed by the upper holding member and the lower holding member, and a discharge pipe was connected to each of the upper holding member and the lower holding member so as to collect water from both ends of the hollow-fiber membranes, bubbles were continuously supplied with the same amount of supply as that in Example 1. A change in differential pressure between the inside and outside of hollow-fiber membranes was measured. The results thereof are shown in FIG. 11.

### Example 5

A filtration process was performed under the same conditions as in Example 1 except that the both-end-water-collection-type filtration module of Example 4 was used, and bubbles were intermittently supplied by an intermittent bubble-jet-type air-diffusing device (intermittent pump) with the same amount of supply as that in Example 1, and a change in differential pressure between the inside and outside of hollow-fiber membranes was measured during the filtration process. A pair of intermittent pumps (two intermittent pumps) were arranged so as to sandwich the lower holding member at positions symmetrical with respect to center of gravity on the side surface of the lower holding member so that bubbles are divided by a plurality of hollow-fiber membranes, not by the lower holding member. The results thereof are shown in FIG. 12.

As shown in FIG. 8, in the filtration module of Example 1, the differential pressure can be suppressed within 50 kPa until the operating time reaches about 100 hours, and excellent maintainability of filtration capability is exhibited. Furthermore, as shown in FIG. 9, in the filtration module provided with the guide cover of Example 2, an increase in the differential pressure can be further suppressed, and the differential pressure can be maintained within 35 kPa. Furthermore, as shown in FIG. 10, in the filtration module of Example 3 in which large bubbles are intermittently supplied by an intermittent pump, an increase in differential pressure can be more markedly reduced. Furthermore, as shown in FIGS. 11 and 12, by using the both-end-water-collection-type filtration module, an increase in differential pressure can be markedly reduced.

### INDUSTRIAL APPLICABILITY

As described above, each of the filtration module and the filtration apparatus in accordance with the present invention has excellent capability of cleaning the surfaces of the hollow-fiber membranes and can maintain high filtration capability. Consequently, the filtration module and the filtration apparatus each can be suitably used as a solid-liquid separation treatment apparatus in various fields.

### REFERENCE SIGNS LIST

1, 11 filtration module

2 hollow-fiber membrane

2a support layer

2b filtration layer

3 upper holding member

4, 14 lower holding member

4a outer frame

4b, 14b fixing portion

5 gas supplying device

6 discharge pipe

7 guide cover

10 filtration apparatus

1. A filtration module comprising:
a plurality of hollow-fiber membranes held in a state of being arranged in parallel in one direction; and
holding members configured to fix both ends of the hollow-fiber membranes,
wherein the hollow-fiber membranes each include a support layer containing, as a main component, polytetrafluoroethylene and a filtration layer disposed on a surface of the support layer and containing, as a main component, polytetrafluoroethylene; and
wherein the ratio of the average length to the average outside diameter of the hollow-fiber membranes is 500 to 3,000.

2. The filtration module according to claim 1, wherein the hollow-fiber membranes are arranged in parallel in the vertical direction.

3. The filtration module according to claim 1, wherein the average outside diameter of the hollow-fiber membranes is 2 to 6 mm, and the average inside diameter of the hollow-fiber membranes is 0.5 to 4 mm.

4. The filtration module according to claim 1, wherein the average length of the hollow-fiber membranes is 3 to 6 m.

5. The filtration module according to claim 1, wherein the ratio of the average inside diameter to the average outside diameter of the hollow-fiber membranes is 0.3 to 0.8.

6. The filtration module according to claim 1, wherein the tensile strength of the hollow-fiber membranes is 50 N or more.

7. The filtration module according to claim 1, wherein the density of the hollow-fiber membranes is 4 to 15 membranes/cm².

8. The filtration module according to claim 1, wherein the porosity of the hollow-fiber membranes is 75% to 90%.

9. The filtration module according to claim 1, wherein the number-average molecular weight of polytetrafluoroethylene, which is a main component of each of the support layer and the filtration layer, is 500,000 to 20,000,000.

10. The filtration module according to claim 1, wherein the filtration layer is formed by winding a stretched polytetrafluoroethylene sheet around a stretched polytetrafluoroethylene tube constituting the support layer, followed by sintering.

11. The filtration module according to claim 2, further comprising a guide cover which surrounds at least an upper portion of the hollow-fiber membranes.

12. A filtration apparatus comprising:
the filtration module according to claim 2; and
a gas supplying device configured to supply a gas from below the filtration module.
